(19) United States
(12) Patent Application Publication
(10) Pub. No.: US 2020/0008214 A1
(43) Pub. Date: Jan. 2, 2020

(54) SYSTEM AND METHOD FOR ANALYSING MULTI-CHANNEL SIGNALS IN TIME SERIES MANNER

(71) Applicant: CHA University Industry-Academic Cooperation Foundation, Pocheon-si (KR)

(72) Inventors: Tai Kyeong JEONG, Seoul (KR); Hyun Ho KIM, Incheon (KR)

(21) Appl. No.: 16/439,872

(22) Filed: Jun. 13, 2019

(30) Foreign Application Priority Data
Jul. 2, 2018 (KR) 10-2018-0076546

(51) Int. Cl. H04W 72/12; H04J 3/16; H04B 17/309

(52) U.S. Cl. CPC H04W 72/1231; H04B 17/309; H04J 3/1694

(57) ABSTRACT

Disclosed a system for analyzing multi-channel signals in a time series manner, the system including: a sensing device including a plurality of sensing modules disposed at different positions of a measurement target, wherein the sensing device is configured for outputting multi-channel signals from the plurality of sensing modules; and a main device for analyzing the multi-channel signals based on a time series based analysis scheme using a shapelet, wherein the main device includes: a signal collector connected to the plurality of sensing modules and configured for receiving the multi-channel signals from the plurality of sensing modules during a predetermined measurement period; a shapelet detector configured for detecting a shapelet pattern of each of the channel signals; and a priority assigner configured for assigning an analysis priority to one of the multi-channel signals based on the shapelet pattern of each of the multi-channel signals.

### CROSS-REFERENCE TO RELATED APPLICATIONS

This application claims the priority of Korean Patent Application No. 10-2018-0076546, filed on Jul. 2, 2018, in the Korean Intellectual Property Office, the disclosure of which is hereby incorporated by reference in its entirety.

### BACKGROUND

### 1. Technical Field

The present disclosure relates to a method and system for time series-based analysis of multi-channel signals collected during a predetermined measurement period.

### 2. Description of the Related Art

Multi-channel signals refer to multiple analog signals collected by multiple sensors during a predetermined measurement period.

A time series-based analysis method may analyze the channel signals by converting the channel signals into time-series data arranged in time sequence, and detecting meaningful information based on a pattern of the time-series data.

Therefore, the time series-based analysis method is widely applied to a system that monitors an sensed object based on analysis results of signals sensed and collected during a predetermined measurement period. For example, the system to which the time series-based analysis method is applied may include infrastructure monitoring, medical signal analysis, economic numerical statistics, and weather information analysis systems.

According to a conventional analysis method, each of a plurality of analysis results corresponding to a plurality of channel signals respectively may be provided by individually analyzing each time series data. In this case, only each analysis result of each channel signal may be provided. Thus, a systematic and comprehensive analysis of the multi-channel signals depends on the user's experience.

Alternatively, according to another conventional analysis method, instead of generating each time-series data corresponding to each channel signal, single time-series data integrally corresponding to the multi-channel signals is generated, and, then, analysis of the single integrated time-series data may lead to analysis result of the multi-channel signals. Even in this case, there is a problem that a process of selecting the multi-channel signals according to importance levels thereof is dependent on the user's experience.

Therefore, it is necessary to provide a time series-based analysis method of multi-channel signals that can improve normalization and integrity in order to reduce the dependency on the user's experience value in the multi-channel signals analysis.

### SUMMARY

A purpose of the present disclosure is to provide a time series-based multi-channel signals analysis system by which normalization and integrity may be improved.

The purposes of the present disclosure are not limited to the above-mentioned purposes. Other purposes and advantages of the present disclosure, as not mentioned above, may be understood from the following descriptions and more clearly understood from the embodiments of the present disclosure. Further, it will be readily appreciated that the purposes and advantages of the present disclosure may be realized by features and combinations thereof as disclosed in the claims.

In one aspect of the present disclosure, there is proposed a system for analyzing multi-channel signals in a time series manner, the system comprising: a sensing device including a plurality of sensing modules disposed at different positions of a measurement target, wherein the sensing device is configured for outputting multi-channel signals from the plurality of sensing modules; and a main device for analyzing the multi-channel signals based on a time series based analysis scheme using a shapelet, wherein the main device includes: a signal collector connected to the plurality of sensing modules and configured for receiving the multi-channel signals from the plurality of sensing modules during a predetermined measurement period; a shapelet detector configured for detecting a shapelet pattern of each of the channel signals; and a priority assigner configured for assigning an analysis priority to one of the multi-channel signals based on the shapelet pattern of each of the multi-channel signals.

In one embodiment of the system, the measurement period includes two or more divided periods, wherein two or more divided periods includes: at least one working period in which the measurement target executes a predetermined task; and at least one rest period following the working period, wherein the measurement target stops the task execution in the rest period.

In one embodiment of the system, the shapelet detector is further configured for: detecting a plurality of unit patterns corresponding to each channel signal based on a length of the shapelet pattern; detecting a minimum distance among distances between each of the plurality of unit patterns and unit patterns in each of the two or more divided periods; and determining one of the plurality of unit patterns as the shape pattern corresponding to each channel signal based on a mixed level between a minimum distance of the at least one working period and a minimum distance of the at least one rest period.

In one embodiment of the system, the priority assignor is further configured for: detecting at least one index corresponding to each channel signal based on the shape pattern of each channel signal; and assigning the analysis priority to one of the multi-channel signals based on the detected at least one index.

In one embodiment of the system, the at least one index corresponding to each channel signal includes: a first distance index indicating a minimum distance among distances between the shapelet pattern and unit patterns of each working period; a second distance index indicating a minimum distance among distances between the shapelet pattern and unit patterns of each rest period; and a distance difference index indicating a minimum value of differences between first distance indexes and second distance indexes.

In one embodiment of the system, the priority assignor is further configured for assigning the analysis priority to a channel signal having a maximum distance difference index among the multi-channel signals.

In one embodiment of the system, the at east one index further includes: a boundary index indicating a median value of the distance difference index; and a quantitative index indicating a ratio between the distance difference index and the boundary index.

In one embodiment of the system, the priority assignor is further configured for assigning the analysis priority to a channel signal having a maximum quantitative index among the multi-channel signals.

In one embodiment of the system, the system further includes a data analyzer configured for analyzing the multi-channel signals based on the analysis priority.

In another aspect of the present disclosure, there is proposed a method for analyzing multi-channel signals in a time series manner, the method comprising: receiving multi-channel signals from a plurality of sensing modules during a predetermined measurement period, wherein the plurality of sensing modules are disposed at different positions of a measurement target; detecting a shapelet pattern of each of the channel signals; detecting at least one index corresponding to each channel signal based on the shape pattern of each of the multi-channel signals; assigning an analysis priority to one of the multi-channel signals based on the detected at least one index; and analyzing the multi-channel signals based on the analysis priority, wherein the measurement period includes two or more divided periods, wherein two or more divided periods includes: at least one working period in which the measurement target executes a predetermined task; and at least one rest period following the working period, wherein the measurement target stops the task execution in the rest period.

In one embodiment of the method, detecting the shapelet pattern includes: detecting a plurality of unit patterns corresponding to each channel signal based on a length of the shapelet pattern; detecting a minimum distance among distances between each of the plurality of unit patterns and unit patterns in each of the two or more divided periods; and determining one of the plurality of unit patterns as the shape pattern corresponding to each channel signal based on a mixed level between a minimum distance of the at least one working period and a minimum distance of the at least one rest period.

In one embodiment of the method, the at least one index corresponding to each channel signal includes: a first distance index indicating a minimum distance among distances between the shapelet pattern and unit patterns of each working period; a second distance index indicating a minimum distance among distances between the shapelet pattern and unit patterns of each rest period; and a distance difference index indicating a minimum value of differences between first distance indexes and second distance indexes.

In one embodiment of the method, assigning the analysis priority includes assigning the analysis priority to a channel signal having a maximum distance difference index among the multi-channel signals.

In one embodiment of the method, the at least one index further includes: a boundary index indicating a median value of the distance difference index; and a quantitative index indicating a ratio between the distance difference index and the boundary index.

In one embodiment of the method, assigning the analysis priority includes assigning the analysis priority to a channel signal having a maximum quantitative index among the multi-channel signals.

According to an embodiment of the present disclosure as described above, an analysis priority is assigned to one of multi-channel signals based on a shapelet pattern of each of the multi-channel signals. Accordingly, there is an advantage that a process for selecting a channel signal having the highest integrity analysis result among the multi-channel signals may be normalized.

### BRIEF DESCRIPTION OF THE DRAWINGS

FIG. 1 shows a time series-based multi-channel signal analysis system according to an embodiment of the present disclosure.

FIG. 2 shows a time series-based multi-channel signal analysis method according to one embodiment of the present disclosure.

FIG. 3, FIG. 4, and FIG. 5 are respectively examples of a priority assignor of FIG. 1.

FIG. 6 shows an example of a sensing device of FIG. 1.

FIG. 7 shows an example of multi-channel signals obtained from the sensing device of FIG. 6.

FIG. 8 shows a first channel signal of the multi-channel signals in FIG. 7.

FIG. 9 shows an example of an unit pattern corresponding to a portion of a first working period of the first channel signal of FIG. 8.

FIG. 10 shows an example of a process of calculating a distance between any two different unit patterns of the first channel signal of FIG. 8.

FIG. 11 shows an example of an unit pattern having a minimum distance from a shapelet pattern during each working period and rest period in the first channel signal of FIG. 8.

FIG. 12, FIG. 13, FIG. 14, FIG. 15, and FIG. 16 are respectively examples of distance difference and boundary indices corresponding to first, second, third, fourth, and fifth channel signals in FIG. 7.

### DETAILED DESCRIPTIONS

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure. The same reference numbers in different figures denote the same or similar elements, and as such perform similar functionality.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, a time series-based multi-channel signal analysis system and a time series-based multi-channel signal analysis method according to embodiments of the present disclosure will be described with reference to the accompanying drawings.

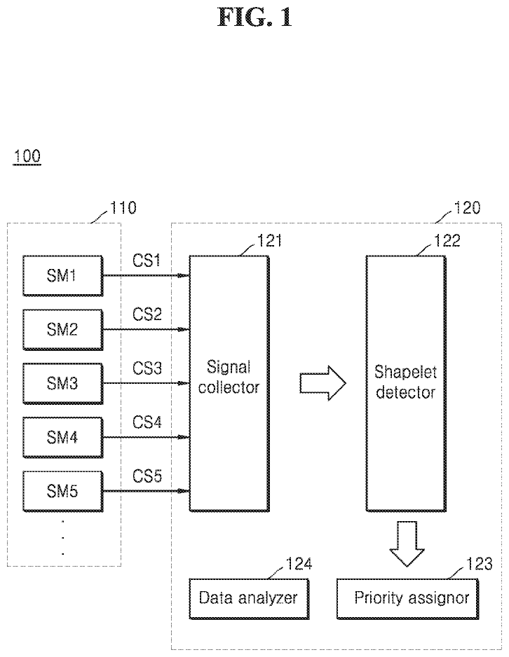

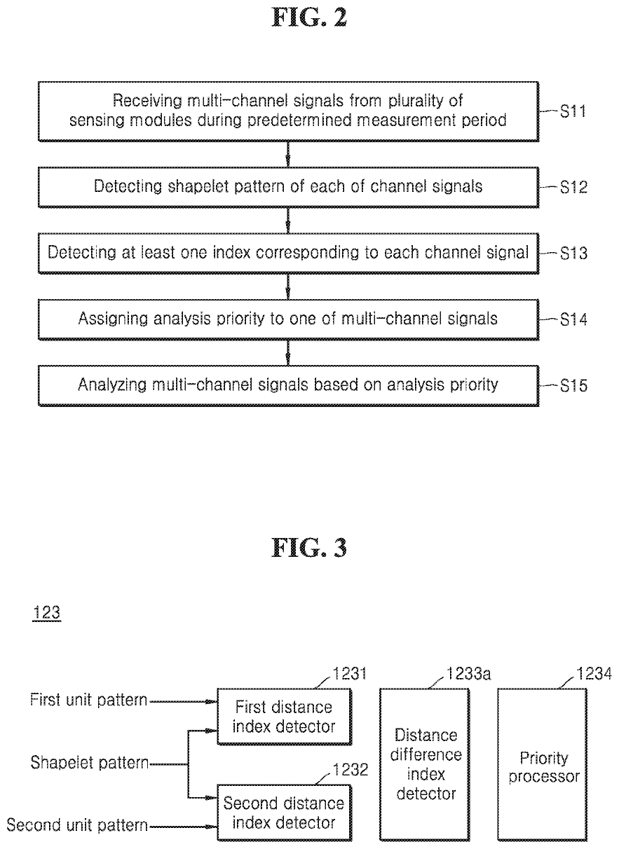

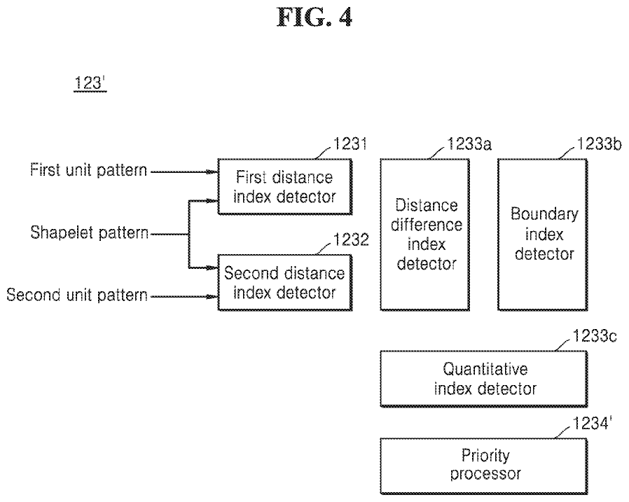

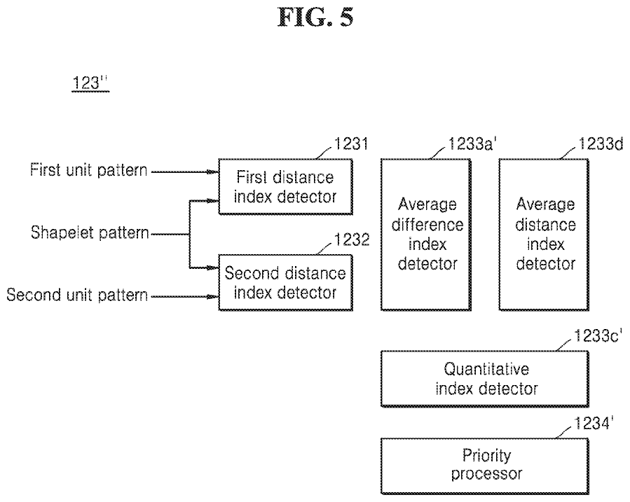

FIG. 1 shows a time series-based multi-channel signal analysis system according to an embodiment of the present disclosure. FIG. 2 shows a time series-based multi-channel signal analysis method according to one embodiment of the present disclosure. FIG. 3, FIG. 4, and FIG. 5 are respectively examples of a priority assignor of FIG. 1.

As shown in FIG. 1, a time series-based multi-channel signal analysis system 100 according to an embodiment of the present disclosure includes a sensing device 110 for outputting multi-channel signals CS1, CS2, CS3, CS4, and CS5 corresponding to a measurement target (not shown), and a main device 120 for analyzing the multi-channel signals based on a time series based analysis scheme using a shapelet.

The sensing device 110 includes a plurality of sensing modules SM1, SM2, SM3, SM4, and SM5 arranged at different positions on the measurement target. The plurality of sensing modules SM1, SM2, SM3, SM4, and SM5 of the sensing device 110 sense and output the multi-channel signals CS1, CS2, CS3, CS4, and CS5 respectively. That is, each channel signal CS is generated by each sensing module SM.

FIG. 1 shows that the sensing device 110 includes five sensing modules SM1, SM2, SM3, SM4, and SM5. This is only an example. The number of the sensing module SMs may vary depending on an application of the present system and a type of the measurement target.

Although not shown in detail in FIG. 1, each sensing module SM may include at least one detection sensor, signal conversion means for converting an output of the detection sensor into a channel signal CS, and power supply means for supplying power to the detection sensor and signal conversion means. Further, each sensing module SM may further include communication means for transmitting and receiving signals.

The main device 120 analyzes the multi-channel signals CS1, CS2, CS3, CS4, and CS5 based on a time series based analysis scheme using a shapelet.

Specifically, as shown in FIG. 2, a method for analyzing, by the main device 120, the multi-channel signals CS1, CS2, CS3, CS4, and CS5 based on a time series based analysis scheme using a shapelet may include an operation S11 of receiving the multi-channel signals CS1, CS2, CS3, CS4, CS5 from the plurality of sensing modules SM1, SM2, SM3, SM4, and SM5 respectively during a predetermined measurement period, an operation S12 of detecting a shapelet pattern of each of the channel signals CS1, CS2, CS3, CS4 and CS5, an operation S13 of detecting at least one index corresponding to each channel signal based on the detected shapelet pattern of each channel signal; and an operation S14 of assigning an analysis priority to one of the multi-channel signals CS1, CS2, CS3, CS4, and CS5 based on the detected at least one index. The time-series data analysis method may further include an operation S15 of analyzing the multi-channel signals CS1, CS2, CS3, CS4, and CS5 based on the analysis priority and providing analysis results.

Reference will be made to FIG. 1 again.

The main device 120 includes a signal collector 121 for receiving the multi-channel signals CS1, CS2, CS3, CS4, and CS5 from the plurality of sensing modules SM1, SM2, SM3, SM4, and SM5 respectively during a predetermined measure period, a shapelet detector 122 for detecting a shapelet pattern of each channel signal of the multi-channel signals CS1, CS2, CS3, CS4, and CS5, and a priority assignor 123 for assigning an analysis priority to one of the multi-channel signals CS1, CS2, CS3, CS4, and CS5 based on the shapelet pattern of each of the multi-channel signals CS1, CS2, CS3, CS4, and CS5. The main device 120 may further include a data analyzer 124 for performing analysis on the multi-channel signals CS1, CS2, CS3, CS4, and CS5 based on the analysis priority.

The signal collector 121 is connected to the plurality of sensing modules SM1, SM2, SM3, SM4 and SM5 and receives the multi-channel signals CS1, CS2, CS3, CS4 and CS5 respectively from the plurality of sensing modules SM1, SM2, SM3, SM4 and SM5 (S11 in FIG. 2).

The measurement period may be divided into two or more periods.

The two or more divided periods include at least one working period and at least one rest period after each working period. During each working period, the measurement target executes a specific task. During each rest period, the measurement target stops executing the task.

That is, each channel signal corresponds to a measurement period, and the measurement period is composed of at least one working period and at least one rest period, which are alternately arranged. Therefore, a portion of each channel signal corresponding to each working period corresponds to the measurement target at the task execution state, while the remaining portion of each channel signal corresponding to each rest period corresponds to the measurement target at the task non-execution state.

When the sensing device 110 includes the first, second, third, fourth and fifth sensing modules SM1, SM2, SM3, SM4 and SM5 as shown in FIG. 1, the signal collector 121 receives the first, second, third, fourth, and fifth signals CS1, CS2, CS3, CS4, and CS5 from the first, second, third, fourth and fifth sensing modules SM1, SM2, SM3, SM4 and SM5 of the sensing device 110 respectively.

In one example, the signal collector 121 may be coupled to the plurality of sensing modules SM1, SM2, SM3, SM4, and SM5 via connection links corresponding to the sensing module SM1, SM2, SM3, SM4, and SM5 respectively. Alternatively, the signal collector 121 may be coupled to the plurality of sensing modules SM1, SM2, SM3, SM4, SM5 via a predetermined wireless network.

The shapelet detector 122 may detect a shapelet pattern of each of the channel signal CS1, CS2, CS3, CS4, and CS5 in a state in which each of the channel signals CS1, CS2, CS3, CS4, and CS5 has been converted to time-series data (S12 in FIG. 2).

In this connection, the shapelet detector 122 may generate time-series data corresponding to each of the channel signals CS1, CS2, CS3, CS4, and CS5 based on a predetermined time slot.

The time slot refers to a time interval at which each of the channel signals CS1, CS2, CS3, CS4, and CS5 is temporally divided. That is, the shapelet detector 122 temporally divides a amplitude of each of the channel signals CS1, CS2, CS3, CS4, and CS5 according to the time slot, to generate the time-series data corresponding to each of the channel signals CS1, CS2, CS3, CS4, and CS5.

The shapelet detector 122 then detects a shapelet pattern corresponding to each time-series data based on a length of the shapelet pattern.

In this connection, the shapelet pattern is selected as an unit pattern for most reliably distinguishing between the rest and working periods, among unit patterns included in each of the channel signals CS1, CS2, CS3, CS4, and CS5.

The length of the shapelet pattern may be set based on at least one of a size of the time-series data, a width of the amplitude, a length of the measurement period, a length of the working period and a length of the rest period. Alternatively, the length of the shapelet pattern ay be arbitrarily set by the user. In an example, for the sake of clear description, a predetermined length of the shapelet pattern is assumed to be 10 time slots. However, this is merely an example. The length of the shapelet pattern may be set to two or more time slots.

Specifically, the shapelet detector 122 detects a plurality of unit patterns corresponding to each channel signal based on the predefined length of the shapelet pattern. In one example, the shapelet detector 122 may divide the time-series data corresponding to each channel signal on at least one time slot basis while shifting along the time slots, thereby to detect a plurality of unit patterns having the predefined length of the shapelet pattern.

In this connection, the number of the plurality of unit patterns is based on the number of time slots in each divided period (that is, working period or rest period), the length of the shapelet pattern, and the number of time slots along which the detector shifts.

In one example, the length of the shapelet pattern is preset to 10 time slots, and the shapelet detector 122 divides the time-series data while the detector shifts on one time slot basis. Each divided period consists of 50 time slots. In this case, the number of unit patterns in each divided period is 41=50−10+1. Therefore, when the measurement period consists of three working periods and three rest periods, the total number of unit patterns corresponding to each channel signal is 246=41*3+41*3.

The shapelet detector 122 detects a minimum distance among distances between each unit pattern and unit patterns of each divided period. That is, the shapelet detector 122 detects distances between the unit patterns corresponding to each channel signal and the unit patterns of each divided period, and detects a minimum distance among the detected distances. Thus, the shapelet detector 122 detects a minimum distance between each unit pattern and each divided period.

In this connection, a distance between two different unit patterns may be calculated based on a difference between amplitudes of the two unit patterns, each amplitude corresponding to each time slot.

In one example, the distance between the two unit patterns may be calculated based on a variance of a difference between the two unit patterns. However, this is only an example. Any statistical formula that may normalize the difference between the two unit patterns may be applied to the distance calculation therebetween.

The shapelet detector 122 detects one of a plurality of unit patterns as a shapelet pattern based on a mixed level between a minimum distance of at least one working period and a minimum distance of at least one rest period. In this connection, the mixed level corresponds to a mixed degree between the minimum distances of at least one working period and at least one rest period. That is, when the minimum distances of the working periods are arranged closely and when the minimum distances of the rest periods are arranged closely, the mixed level is relatively low. To the contrary, when a minimum distance of the rest period is positioned between the minimum distances of the working periods, the mixed level has a relatively high value.

In one example, the shapelet detector 122 detects the minimum distance between each unit pattern and each working period and detects the minimum distance between each unit pattern of each rest period, and determines a specific unit pattern as a shapelet pattern, wherein a mixed level between the minimum distance between the working period and the specific unit pattern and the minimum distance between the rest period and the specific unit pattern is the lowest. That is, when the minimum distance between each working period and the specific unit pattern is most clearly distinguished from the minimum distance between each rest period and the specific unit pattern, the specific unit pattern is selected as the shapelet pattern.

Next, the shapelet detector 122 detects the shapelet pattern of each channel signal by repeating the detection of the shapelet pattern for each of the multi-channel signals.

That is, according to the example of FIG. 1, the shapelet detector 122 detects first, second, third, fourth, and fifth shapelet patterns individually corresponding to the first, second, third, fourth and fifth channel signals CS1, CS2, CS3, CS4, and CS5.

The priority assignor 123 assigns an analysis priority to one of the multi-channel signals based on the shapelet pattern of each of the multi-channel signals CS1, CS2, CS3, CS4, and CS5.

Specifically, the priority assignor 123 detects at least one index corresponding to each of the channel signals CS1, CS2, CS3, CS4, and CS5 based on the shapelet pattern of each of the channel signals CS1, CS2, CS3, CS4, and CS5 (S13 in FIG. 2). Then, the priority assignor 123 assigns the analysis priority to one channel signal based on the detected at least one index corresponding to each channel signal (S14 in FIG. 2).

In this connection, the analysis priority corresponds to an easiness or clearness degree of distinction between working and rest periods for each channel signal. Thus, the analysis priority may correspond to an order in which the analysis is performed between the channel signals or may correspond to a weight applied to a importance level of an analysis result between the channel signals.

At least one index refers to a parameter for normalizing a clarity or integrity of the analysis result of each of the channel signals CS1, CS2, CS3, CS4 and CS5.

For example, at least one index corresponding to each of the channel signals CS1, CS2, CS3, CS4, and CS5 has a first distance index as a minimum distance among distances between the shapelet pattern and unit patterns of each working period, a second distance index as a minimum distance among distances between the shapelet pattern and unit patterns of each rest period, and a distance difference index corresponding to a minimum value of differences between the first distance indexes and the second distance indexes.

In this case, the priority assignor 123 assigns the analysis priority to one channel signal having the largest distance difference index among the multi-channel signals CS1, CS2, CS3, CS4, and CS5.

That is, as shown in FIG. 3, the priority assignor 123 may include a first distance index detector 1231, a second distance index detector 1232, a distance difference index detector 1233a, and a priority processor 1234.

The first distance index detector 1231 detects a first distance index as a minimum distance between each working period and the shapelet pattern. In this connection, the minimum distance between each working period and the shapelet pattern refers to the minimum distance among the distance between the unit patterns of each working period and the shapelet pattern.

The second distance index detector 1232 detects a second distance index as a minimum distance between each rest period and the shapelet pattern. In this connection, the minimum distance between each rest period and the shapelet pattern refers to the minimum distance among distances between unit patterns of each resting period and the shapelet pattern.

The distance difference index detector 1233a detects a distance difference index corresponding to a minimum value of the distances between the first distance indexes and the second distance indexes.

The priority processor 1234 detects a maximum value among a plurality of distance difference indexes corresponding to the multi-channel signals CS1, CS2, CS3, CS4, and CS5, and assigns the analysis priority to the channel signal corresponding to the maximum distance difference index.

The priority assignor 123 as shown in FIG. 3 assigns the analysis priority according to the distance difference index of each channel signal. That is, a parameter used as a reference for the assignment of the analysis priority is the distance difference index.

Alternatively, according to one embodiment of the present disclosure, the parameter used as the reference for the assignment f the analysis priority is not limited to the distance difference index, but may be selected from other parameters.

In one example, the at least one index corresponding to each of the channel signals CS1, CS2, CS3, CS4, and CS5 may include a first distance index, a second distance index, and a distance difference index, a boundary index corresponding to a median value of the distance difference index, and a quantitative index corresponding to a ratio between the distance difference and the boundary index.

In this connection, the quantitative index may be a parameter proportional to the distance difference index, and inversely proportional to the boundary index.

In this case, a priority assignor 123′ assigns the analysis priority to one channel signal having the largest quantitative index among the multi-channel signals CS1, CS2, CS3, CS4, and CS5.

That is, as shown in FIG. 4, the priority assignor 123′ includes a first distance index detector 1231, a second distance index detector 1232, a distance difference index detector 1233a, a boundary index detector 1233b, a quantitative index detector 1233c, and a priority processor 1234′. In this connection, the priority assignor 123′ of FIG. 4 is the same as the priority assignor 123 of FIG. 3 except that the priority assignor 123′ further includes the boundary index detector 1233b and the quantitative index detector 1233c, and the priority processor 1234′ assigns the analysis priority based on the quantitative index. Thus, redundant descriptions therebetween will be omitted below.

The boundary index detector 1233b may detect the boundary index based on the average value of the first and second distance indexes corresponding to the distance difference index.

The quantitative index detector 1233c may detect the quantitative index based on a value obtained by dividing the distance difference index by the boundary index.

The priority processor 1234′ detects a maximum value among a plurality of quantitative indexes corresponding to the multi-channel signals CS1, CS2, CS3, CS4, and CS5, and then assigns the analysis priority to the channel signal corresponding to the maximum quantitative index.

In one example, the quantitative index may be derived using a scheme different from a scheme by which the quantitative index is derived the priority in the assignor 124′ shown in FIG. 4.

In one example, at least one index corresponding to each of the channel signals CS1, CS2, CS3, CS4, and CS5 may include a first distance index, a second distance index, an average difference index, an average distance index corresponding to an average value of the first and second distance indices, and a quantitative index corresponding to a ratio of the average difference index and the average distance index.

In this connection, each of the average difference index and the average distance index may correspond to a first average value between the first distance indices and a second average value between the second distance indices. In one example, the average difference index may be calculated as a difference between the first average value and the second average value. The average distance index may be calculated as the average of the first and second average values.

In this case, the quantitative index may be calculated as a value that is proportional to the average difference index, and is inversely proportional to the average distance index.

In this case, as shown in FIG. 5, the priority assignor 123″ may include a first distance index detector 1231, a second distance index detector 1232, an average difference index detector 1233a′, an average distance index detector 1233d, a quantitative index detector 1233c′, and a priority processor 1234′. In this connection, the priority assignor 123″ of FIG. 5 is the same as the priority assignor 123′ of FIG. 4 except that the priority assignor 123″ includes the average difference index detector 1233a′ and the average distance index detector 1233d instead of the distance difference index detector 1233a and the boundary index detector 1233b, and the quantitative index detector 1233c′ detects the quantitative index based on the average difference index and the average distance index. Thus, redundant description therebetween will be omitted.

The average difference index detector 1233a′ may detect an average difference index based on a difference between a first average value of the first distance indices and a second average value of the second distance indices.

The average distance index detector 1233d may detect an average distance index based on an average of the first average value and the second average value.

The quantitative index detector 1233c′ may detect the quantitative index based on a value obtained by dividing the average difference index by the average distance index.

Although not shown separately, the quantitative index may be derived in a scheme that differs from the above defined scheme.

In one example, at least one index corresponding to each of the channel signals CS1, CS2, CS3, CS4, and CS5 may include a first distance index, a second distance index, a distance difference index, a standard deviation index indicating a standard deviation between the first distance index and the second distance index, and a quantitative index corresponding to a ratio of the distance difference index and the standard deviation index. In this case, the quantitative index may be calculated as a value that is proportional to the distance difference index and is inversely proportional to the standard deviation index.

In another example, at least one index corresponding to each of the channel signals CS1, CS2, CS3, CS4, and CS5 may include a first distance index, a second distance index, an average difference index, a standard deviation index indicating a standard deviation between the first distance index and the second distance index, and a quantitative index corresponding to a ratio of the average difference index and the standard deviation index. In this case, the quantitative index may be calculated to be directly proportional to the average difference index, but to be inversely proportional to the standard deviation index.

The data analyzer 124 analyzes the multi-channel signals CS1, CS2, CS3, CS4, and CS5 based on the analysis priority (S15 in FIG. 20). In this connection, the data analyzer 124 may provide the analysis result upon the user's request.

For example, the data analyzer 124 may assign a maximum weight to the analysis result corresponding to the channel signal to which the analysis priority is assigned. Alternatively, the data analyzer 124 may preferentially provide and display the analysis result corresponding to the channel signal to which the analysis priority is assigned.

Next, a case where a time series-based multi-channel signal analysis system according to an embodiment of the present disclosure is applied to brain wave analysis will be described.

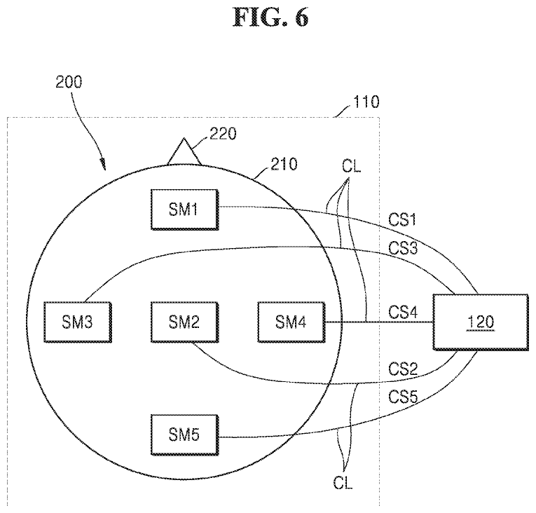

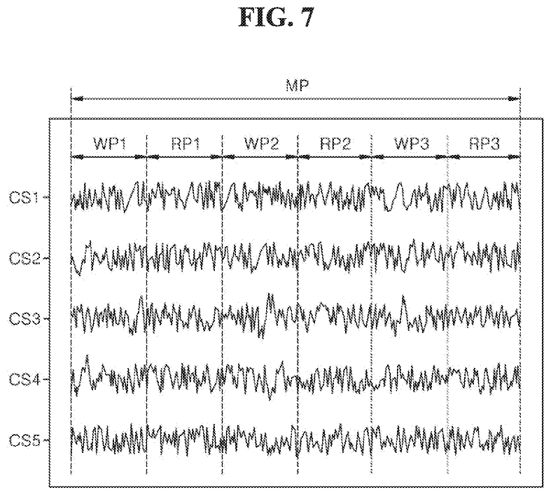

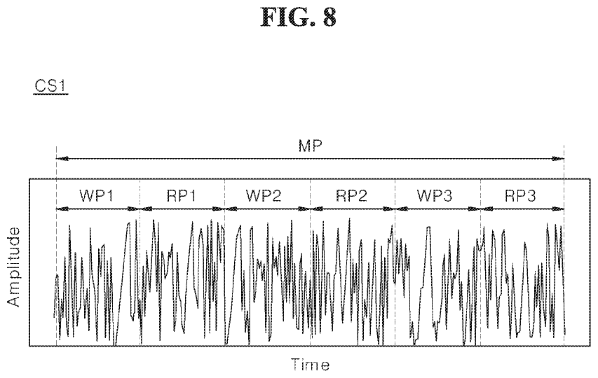

FIG. 6 shows an example of a sensing device of FIG. 1. FIG. 7 shows an example of multi-channel signals obtained from the sensing device of FIG. 6.

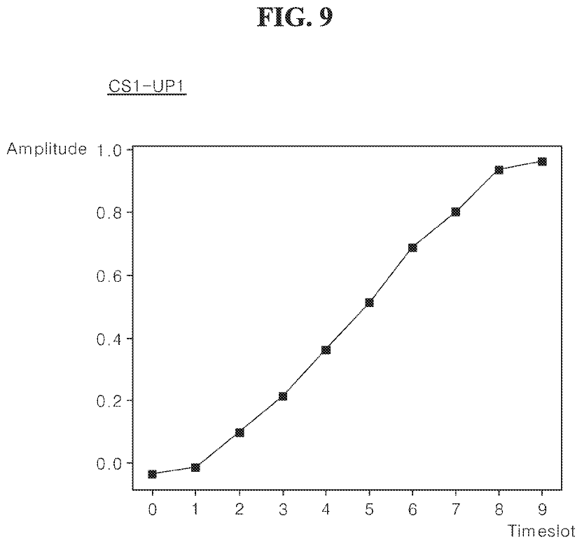

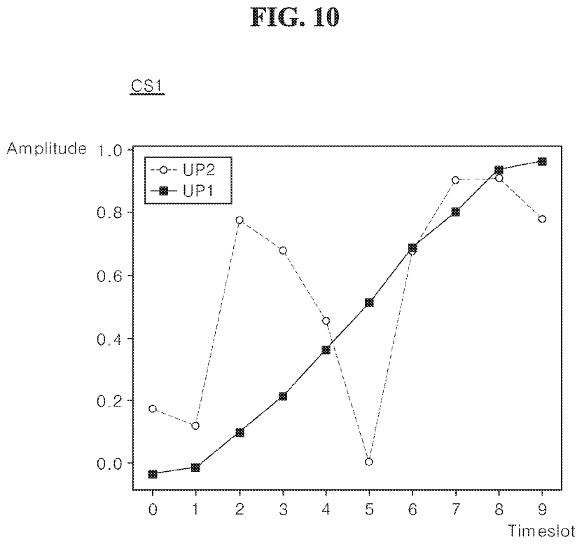

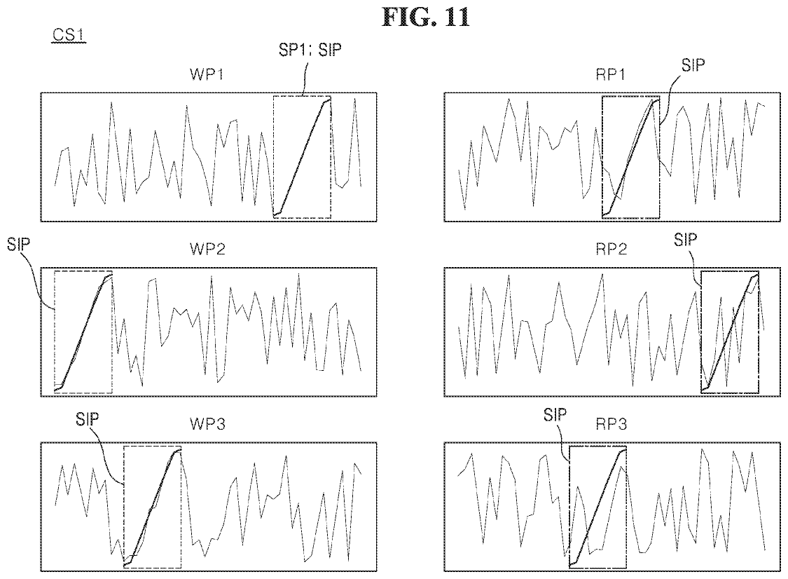

FIG. 8 shows a first channel signal of the multi-channel signals in FIG. 7. FIG. 9 shows an example of an unit pattern corresponding to a portion of a first working period of the first channel signal of FIG. 8. FIG. 10 shows an example of a process of calculating a distance between any two different unit patterns of the first channel signal of FIG. 8. FIG. 11 shows an example of an unit pattern having a minimum distance from a shapelet pattern during each working period and rest period in the first channel signal of FIG. 8.

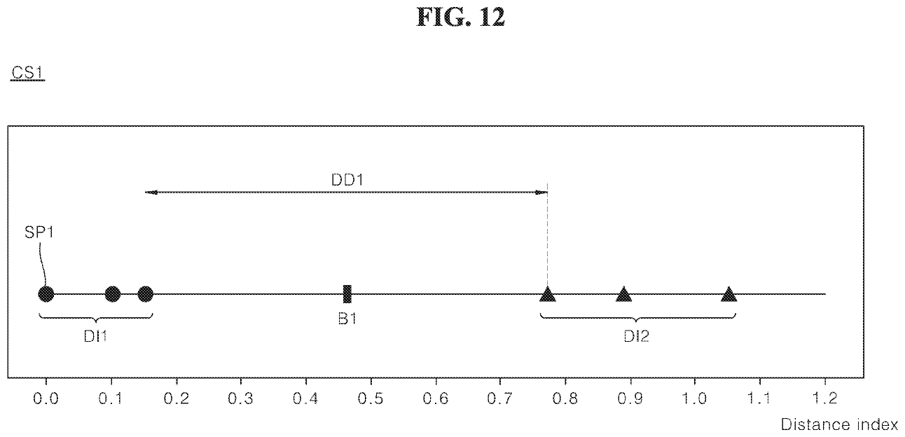

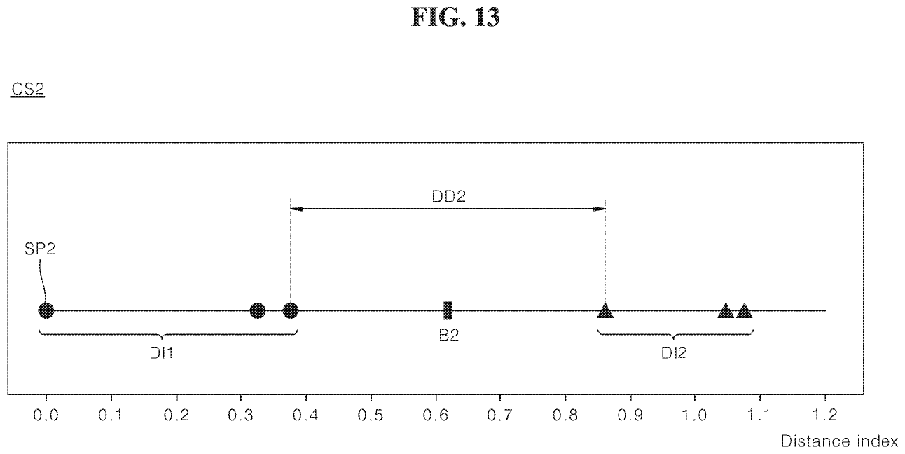

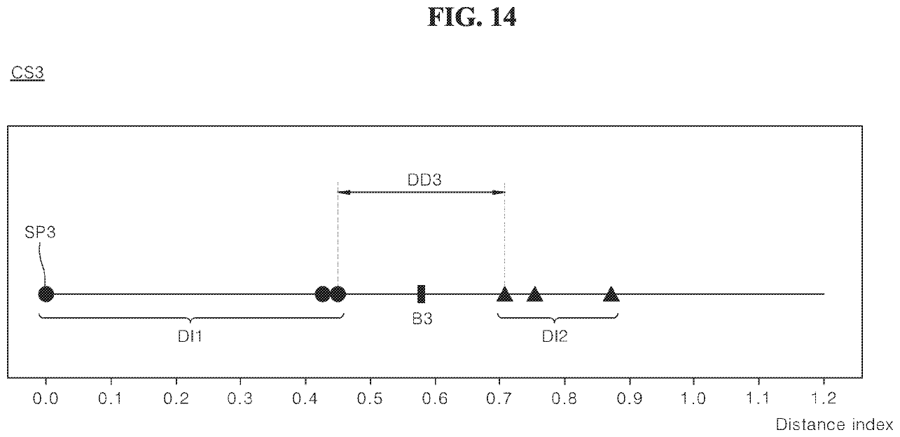

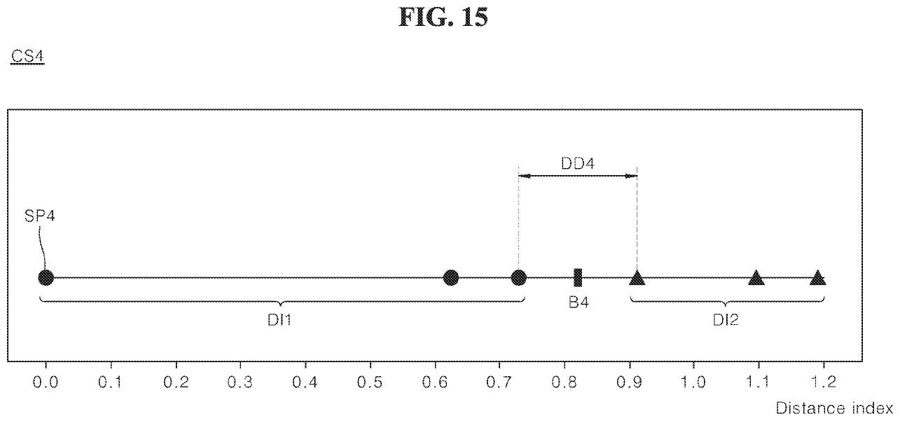

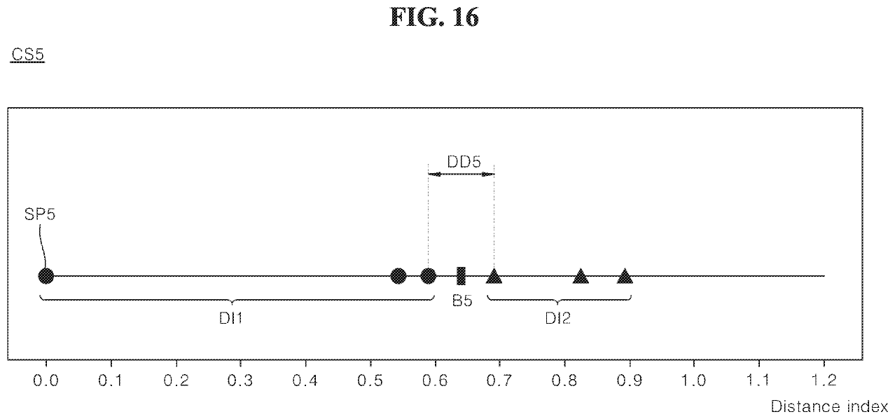

FIG. 12, FIG. 13, FIG. 14, FIG. 15, and FIG. 16 are respectively examples of distance difference and boundary indices corresponding to first, second, third, fourth, and fifth channel signals in FIG. 7.

As shown in FIG. 6, the time series-based multi-channel signals analysis system (110 and 120: 100 in FIG. 1) according to an embodiment of the present disclosure may be a system for analyzing brain waves. In this case, the measurement target 200 on which the sensing device 110 is disposed is a head 210 of a subject.

That is, the sensing device 110 includes the plurality of sensing modules SM1, SM2, SM3, SM4, and SM5 disposed at different positions in the subject's head 200, and connection links CLs for connecting the sensing modules SM1, SM2, SM3, SM4, and SM5 to the main device 120.

In one example, the plurality of sensing modules SM1, SM2, SM3, SM4, and SM5 may include a first sensing module SM1 disposed on a forehead 210 of the subject's head above a nose 220, a second sensing module SM2 disposed on a top of the head of the subject, a third sensing module SM3 and a fourth sensing module SM4 disposed respectively on left and right sides to the top of the head 200, and a fifth sensing module SM5 disposed on a back side of the head opposite the nose 220.

The plurality of sensing modules SM1, SM2, SM3, SM4, and SM5 output the multi-channel signals CS1, CS2, CS3, CS4, and CS5 to the main device 120 via respective connection links CL.

The main device 120 receives the multi-channel signals CS1, CS2, CS3, CS4, and CS5 corresponding to each measurement period and analyzes the multi-channel signals CS1, CS2, CS3, CS4, and CS5 based on a time-series analysis scheme.

The signal collector 121 of the main device 120 receives the multi-channel signals CS1, CS2, CS3, CS4, and CS5 from the plurality of sensing modules SM1, SM2, SM3, SM4, and SM5 during a predetermined measurement period respectively (S11 in FIG. 2).

As shown in FIG. 7, the multi-channel signals CS1, CS2, CS3, CS4, and CS5 correspond to the measurement period MP. For example, each of the channel signals CS1, CS2, CS3, CS4, and CS5 may be an analog signal whose amplitude varies in a predetermined amplitude range during the measurement period MP.

The measurement period MP is composed of two or more consecutive divided periods WP1, RP1, WP2, RP2, WP3, and RP3. The two or more divided periods include at least one working period WP1, WP2, and WP3, and at least one rest period RP1, RP2, and RP3 arranged after each working period WP1, WP2, or WP3.

Hereinafter, as illustrated in FIG. 7, the measurement period MP is assumed to have the first, second and third working periods WP1, WP2 and WP3, and the first, second and third rest periods RP1, RP2 and RP3 arranged in an alternated manner with the first, second and third working periods WP1, WP2 and WP3.

As shown in FIG. 8, a first channel signal CS1 corresponding to a first sensing module (SM1 in FIG. 6) among the multi-channel signals CS1, CS2, CS3, CS4, and CS5 has the first, second and third working periods WP1, WP2 and WP3, and the first, second and third rest periods RP1, RP2 and RP3 arranged in an alternated manner with the first, second and third working periods WP1, WP2 and WP3 and is an analog signal having an amplitude varying over time.

The shapelet detector 122 of the main device 120 may detect the shapelet pattern of each of the channel signals CS1, CS2, CS3, CS4, and CS5 while having converted each of the channel signals CS1, CS2, CS3, CS4, CS5 into time-serials data (S12 in FIG. 2).

In one example, the shapelet detector 122 may temporally divide each of the channel signals CS1, CS2, CS3, CS4, and CS5 based on a predetermined time slot, thereby to convert each of the channel signals CS1, CS2, CS3, CS4, CS5 into time-serials data.

The shapelet detector 122 detects a shapelet pattern corresponding to each of the channel signals CS1, CS2, CS3, CS4, and CS5, based on the length of the shapelet pattern.

In this connection, the shapelet pattern is selected as an unit pattern for most reliably distinguishing between the rest and working periods, among unit patterns included in each of the channel signals CS1, CS2, CS3, CS4, and CS5.

The length of the shapelet pattern may be set based on at least one of a size of the time-series data, a width of the amplitude, a length of the measurement period, a length of the working period and a length of the rest period. Alternatively, the length of the shapelet pattern ay be arbitrarily set by the user. In an example, for the sake of clear description, a predetermined length of the shapelet pattern is assumed to be 10 time slots.

The shapelet detector 122 detects a plurality of unit patterns corresponding to each channel signal based on the predefined length of the shapelet pattern. In one example, the shapelet detector 122 may divide the time-series data corresponding to each channel signal on at least one time slot basis while shifting along the time slots, thereby to detect a plurality of unit patterns having the predefined length of the shapelet pattern.

For example, as shown in FIG. 9, an unit pattern UP1 corresponding to a portion of the first working period WP1 of the first channel signal CS1 of FIG. 8 has amplitude values corresponding to 10 time slot (horizontal axis 0 to 9).

The shapelet detector 122 detects a minimum distance among distances between each unit pattern and unit patterns of each divided period. That is, the shapelet detector 122 detects distances between the unit patterns corresponding to each channel signal and the unit patterns of each divided period, and detects a minimum distance among the detected distances. Thus, the shapelet detector 122 detects a minimum distance between each unit pattern and each divided period.

In this connection, a distance between two different unit patterns may be calculated based on a difference between amplitudes of the two unit patterns, each amplitude corresponding to each time slot

For example, referring to FIG. 10 and Equation 1 below, the distance between two unit patterns UP1 and UP2 included in the first channel signal CS1 is calculated as a variance of the difference between amplitudes of the two unit patterns UP1 and UP2:

$$distance = \sqrt{\frac{1}{N} {\sum }_{i = 0}^{N - 1} {( UP {2}_{i} - UP {1}_{i} )}^{2}} \qquad [ Equation 1 ]$$

Equation 1 illustrates a case where the first unit pattern UP1 is a reference pattern.

In Equation 1, N denotes a length of the shapelet pattern and i denotes a time slot in each unit pattern. For example, when the length of the shapelet pattern is 10 time slots, N is 10, and i is a range of from 0 to N−1 (0≤i≤N−1). UP1i may refer to an amplitude corresponding to an i-th time slot in the first unit pattern, and UP2i may refer to an amplitude corresponding to an i-th time slot in the second unit pattern.

Using this process, the shapelet detector 122 detects the minimum distance between each working period WP1, WP2, and WP3, and each unit pattern, and the minimum distance between each rest period RP1, RP2, and RP3 and each unit pattern. Next, the shapelet detector 122 detects a mixed level between the minimum distance of each of the working periods WP1, WP2, and WP3 and the minimum distance of each of the rest periods RP1, RP2, and RP3. Then, the shapelet detector 122 determines a specific unit pattern as a shapelet pattern, wherein a mixed level between the minimum distance between the working period and the specific unit pattern and the minimum distance between the rest period and the specific unit pattern is the lowest.

The priority assignor 123 of the main device 120 assigns the analysis priority to one of the multi-channel signals based on the shapelet patterns of the multi-channel signals CS1, CS2, CS3, CS4 and CS5.

Specifically, the priority assignor 123 detects at least one index corresponding to each of the channel signals CS1, CS2, CS3, CS4, and CS5 based on each of the shapelet patterns of the channel signals CS1, CS2, CS3, CS4, and CS5 (S13 in FIG. 2). Then, the priority assignor 123 assigns the analysis priority to one channel signal based on the detected at least one index corresponding to each channel signal (S14 in FIG. 2).

For example, at least one index corresponding to each of the channel signals CS1, CS2, CS3, CS4, and CS5 includes a first distance index as a minimum distance among distances between the shapelet pattern and unit patterns of each working period, a second distance index as a minimum distance among distances between the shapelet pattern and unit patterns of each rest period, and a distance difference index corresponding to a minimum value of differences between the first distance indexes and the second distance indexes.

As shown in FIG. 11, a portion of the first working period WP1 of the first channel signal CS1 may be detected by the shapelet detector 122 as a shapelet pattern SP1 corresponding to the first channel signal CS1.

The first distance index detector 1231 (in FIG. 3) of the priority assignor 123 detects a first distance index as the minimum distance between each working period WP1, WP2 and WP3 and the shapelet pattern. The second distance index detector 1232 detects a second distance index as a minimum distance between each of the rest periods RP1, RP2, and RP3 and the shapelet pattern.

As shown in FIG. 11, one of the unit patterns of each working period WP1, WP2, and WP3, which has the closest distance (that is, has the most approximate shape) to the shapelet pattern SP1 is detected as an approximate unit pattern SIP. The approximate unit pattern of each working period WP1, WP2, WP3 corresponds to the first distance index.

As shown in FIG. 11, one of the unit patterns of each rest period RP1, RP2, and RP3, which has the closest distance (that is, has the most approximate shape) to the shapelet pattern SP1 detected as is an approximate unit pattern SIP. The approximate unit pattern SIP of each rest period RP1, RP2, RP3 corresponds to the second distance index.

The distance difference index detector 1233a of the priority assignor 123 detects a distance difference index corresponding to a minimum value of the distances between the first distance indexes and the second distance indexes.

As shown in FIG. 12, the distance difference index detector 1233a detects a distance difference index DD1 corresponding to the minimum distance among the distances between the first distance indexes DI1 and the second distance indexes DI2.

The boundary index detector 1233c detects a boundary index B1 as an average value between one first distance index (the rightmost DI1 in FIG. 12) corresponding to the distance difference index DD1 and one second distance index (the leftmost DI2 in FIG. 12) corresponding to the distance difference index DD1.

The priority assignor 123 repeats the process of detecting the at least one index for each of the first, second, third, fourth and fifth channel signals CS1, CS2, CS3, CS4 and CS5.

Thus, as shown in FIGS. 12, 13, 14, 15 and 16, distance difference indexes DD1, DD2, DD3, DD4, and DD5 and boundary indices B1, B2, B3, B4, and B5 corresponding to the first, second, third, fourth and fifth channel signals CS1, CS2, CS3, CS4 respectively may be detected.

FIG. 12, FIG. 13, FIG. 14, FIG. 15 and FIG. 16 show that as each of the distance difference indices DD1, DD2, DD3, DD4, and DD5 is larger, the distinction between the first distance index DI1 and the second distance index DI2 may be more intuitive and more reliable.

Accordingly, the priority processor 1234 of the priority assignor 123 may assign the analysis priority to the first channel signal CS1 having the largest distance difference index DD1 among the distance difference indices DD1, DD2, DD3, DD4 and DD5 among the first, second, third, fourth and fifth channel signals CS1, CS2, CS3, CS4 and CS5.

Alternatively, when comparing FIG. 12, FIG. 13, FIG. 14, FIG. 15 and FIG. 16 with each other, each of the first distance indices DI1 and each of the second distance indices DI2 are arranged around each of the boundary indices B1, B2, B3, B4, and B5. Therefore, when the analysis priority may be assigned based on the quantitative indices corresponding to the boundary indices B1, B2, B3, B4 and B5 as well as the distance difference indices DD1, DD2, DD3, DD4 and DD5, a distribution of the distance indexes may be more normalized and standardized.

Accordingly, the priority assignor 123 may further include a quantitative index detector 1233c for detecting the quantitative index (=DD/B) corresponding to the ratio of the distance difference index DD and the boundary index B. In this connection, the quantitative index may have a larger value as the distance difference index DL) is larger or as the boundary index B is smaller.

The priority processor 1234 of the priority assignor 123 assigns the analysis priority to the first channel signal CS1 having the largest quantitative index among the first, second, third, fourth and fifth channel signals CS1, CS2, CS3, CS4 and CS5.

As described above, the analysis system 100 according to an embodiment of the present disclosure includes the main device 120 for analyzing the multi-channel signals CS1, CS2, CS3, CS4, and CS5 based on a time series based analysis scheme using a shapelet. The main device 120 includes the priority assignor 123 for assigning the analysis priority to one of the multi-channel signals CS1, CS2, CS3, CS4, and CS5 based on the at least one index DD corresponding to each of the multi-channel signals CS1, CS2, CS3, CS4, and CS5.

In this connection, the at least one index corresponding to each channel signal is calculated using statistical formula based on the shapelet pattern. Thus, the assigning of the analysis priority between the multi-channel signals may be performed quantitatively based on the index. Therefore, there is an advantage that the integrity of the analysis result may be improved.

Further, according to one embodiment of the present disclosure, the user does not individually review the analysis result for each of the multi-channel signals, but rather may review first the analysis result of the channel signal to which the analysis priority is assigned. This may improve a convenience in terms of use of the multi-channel signal analysis system.

As described above, the present disclosure is described with reference to the drawings. However, the present disclosure is not limited by the embodiments and drawings disclosed in the present specification. It will be apparent that various modifications may be made thereto by those skilled in the art within the scope of the present disclosure. Furthermore, although the effect resulting from the features of the present disclosure has not been explicitly described in the description of the embodiments of the present disclosure, it is obvious that a predictable effect resulting from the features of the present disclosure should be recognized.

What is claimed is:

1. A system for analyzing multi-channel signals in a time series manner, the system comprising:
a sensing device including a plurality of sensing modules disposed at different positions of a measurement target, wherein the sensing device is configured for outputting multi-channel signals from the plurality of sensing modules; and
a main device for analyzing the multi-channel signals based on a time series based analysis scheme using a shapelet,
wherein the main device includes:
a signal collector connected to the plurality of sensing modules and configured for receiving the multi-channel signals from the plurality of sensing modules during a predetermined measurement period;
a shapelet detector configured for detecting a shapelet pattern of each of the channel signals; and
a priority assigner configured for assigning an analysis priority to one of the multi-channel signals based on the shapelet pattern of each of the multi-channel signals.

2. The system of claim 1, wherein the measurement period includes two or more divided periods,
wherein two or more divided periods includes:
at least one working period in which the measurement target executes a predetermined task; and
at least one rest period following the working period, wherein the measurement target stops the task execution in the rest period.

3. The system of claim 2, wherein the shapelet detector is further configured for:
detecting a plurality of unit patterns corresponding to each channel signal based on a length of the shapelet pattern;
detecting a minimum distance among distances between each of the plurality of unit patterns and unit patterns in each of the two or more divided periods; and
determining one of the plurality of unit patterns as the shape pattern corresponding to each channel signal based on a mixed level between a minimum distance of the at least one working period and a minimum distance of the at least one rest period.

4. The system of claim 3, wherein the priority assignor is further configured for:
detecting at least one index corresponding to each channel signal based on the shape pattern of each channel signal; and
assigning the analysis priority to one of the multi-channel signals based on the detected at least one index.

5. The system of claim 4, wherein the at least one index corresponding to each channel signal includes:
a first distance index indicating a minimum distance among distances between the shapelet pattern and unit patterns of each working period;
a second distance index indicating a minimum distance among distances between the shapelet pattern and unit patterns of each rest period; and
a distance difference index indicating a minimum value of differences between first distance indexes and second distance indexes.

6. The system of claim 5, wherein the priority assignor is further configured for assigning the analysis priority to a channel signal having a maximum distance difference index among the multi-channel signals.

7. The system of claim 5, wherein the at least one index further includes:
a boundary index indicating a median value of the distance difference index; and
a quantitative index indicating a ratio between the distance difference index and the boundary index.

8. The system of claim 7, wherein the priority assignor is further configured for assigning the analysis priority to a channel signal having a maximum quantitative index among the multi-channel signals.

9. The system of claim 1, wherein the system further includes a data analyzer configured for analyzing the multi-channel signals based on the analysis priority.

10. A method for analyzing multi-channel signals in a time series manner, the method comprising:
receiving multi-channel signals from a plurality of sensing modules during a predetermined measurement period, wherein the plurality of sensing modules are disposed at different positions of a measurement target;
detecting a shapelet pattern of each of the channel signals;
detecting at least one index corresponding to each channel signal based on the shape pattern of each of the multi-channel signals;
assigning an analysis priority to one of the multi-channel signals based on the detected at least one index; and
analyzing the multi-channel signals based on the analysis priority,
wherein the measurement period includes two or more divided periods,
wherein two or more divided periods includes:
at least one working period in which the measurement target executes a predetermined task; and
at least one rest period following the working period, wherein the measurement target stops the task execution in the rest period.

11. The method of claim 10, wherein detecting the shapelet pattern includes:
detecting a plurality of unit patterns corresponding to each channel signal based on a length of the shapelet pattern;
detecting a minimum distance among distances between each of the plurality of unit patterns and unit patterns in each of the two or more divided periods; and
determining one of the plurality of unit patterns as the shape pattern corresponding to each channel signal based on a mixed level between a minimum distance of the at least one working period and a minimum distance of the at least one rest period.

12. The method of claim 10, wherein the at least one index corresponding to each channel signal includes:
a first distance index indicating a minimum distance among distances between the shapelet pattern and unit patterns of each working period;
a second distance index indicating a minimum distance among distances between the shapelet pattern and unit patterns of each rest period; and
a distance difference index indicating a minimum value of differences between first distance indexes and second distance indexes.

13. The method of claim 12, wherein assigning the analysis priority includes assigning the analysis priority to a channel signal having a maximum distance difference index among the multi-channel signals.

14. The method of claim 12, wherein the at least one index further includes:
a boundary index indicating a median value of the distance difference index; and
a quantitative index indicating a ratio between the distance difference index and the boundary index.

15. The method of claim 14, wherein assigning the analysis priority includes assigning the analysis priority to a channel signal having a maximum quantitative index among the multi-channel signals.
